(19) United States
(12) Patent Application Publication
(10) Pub. No.: US 2017/0282494 A1
(43) Pub. Date: Oct. 5, 2017

(54) FOAMABLE HOT MELT GASKET SEALANTS AND USE THEREOF

(71) Applicants: HENKEL IP & HOLDING GMBH, Duesseldorf (DE); HENKEL AG & CO. KGAA, Duesseldorf (DE)

(72) Inventors: Valerie ALEXIS, Edison, NJ (US); Maria Cristina Barbosa DeJesus, Basking Ridge, NJ (US); Charles W. Paul, Morristown, NJ (US); Drik Kasper, Duesseldorf (DE); Marcus Heeman, Neuss (DE); Sebastian Kostyra, Monheim (DE)

(21) Appl. No.: 15/625,577

(22) Filed: Jun. 16, 2017

Related U.S. Application Data
(63) Continuation of application No. PCT/US15/63694, filed on Dec. 3, 2015.
(60) Provisional application No. 62/093,778, filed on Dec. 18, 2014.

(51) Int. Cl. B32B 5/18; B32B 7/12; B32B 27/36; B32B 27/06; B32B 17/06; C09J 5/08; C09J 153/02; C09J 9/00; C09J 11/06; C08J 9/08; C08J 9/00; C09K 3/10; B32B 27/32; B32B 15/04

(52) U.S. Cl. CPC B32B 5/18; B32B 27/32; B32B 7/12; B32B 27/365; B32B 27/065; B32B 17/066; B32B 15/046; C09J 153/02; C09J 9/00; C09J 11/06; C08J 9/08; C08J 9/0061; C09K 3/10; C09J 5/08; B32B 2038/0084

(57) ABSTRACT

The invention relates to a one-part, foamable hot melt gasket sealant. The foamable hot melt adhesive comprises greater than about 35 wt % of a rubber block copolymer, a tackifier and less than about 5 wt % of a wax. The foamable hot melt adhesive can be applied onto a space in between two mating surfaces without expensive foam-in-place equipment. The foamable hot melt gasket sealant is particularly suitable in automotive applications, electrical component and technical lighting sectors.

### FIELD OF THE INVENTION

The present invention relates to a one-part, foamable hot melt gasket sealant. The foamable hot melt gasket sealant is particularly suitable in automotive applications, electrical component and technical lighting sectors.

### BACKGROUND OF THE INVENTION

A gasket seals and fills a space in between two mating surfaces and improves the contact between the two surfaces when they are joined together under compression. A good gasket has adequate flexibility and tightly fills the space in between the two surfaces by conforming and compensating for any irregularities of the two joining surfaces. While a variety of bonding agents may be used for gaskets, a sealant is preferred over other bonding agents. Hot melt adhesives, for instance, do not have the flexibility and elongation necessary for gasket sealing. Sealants, on the other hand, provide adequate flexibility and elongation to remain bonded to two substrates having different thermal coefficients of expansion or differing elongation under stress. Gasket sealants provide thermal and electrical insulation, dampen vibration and sound, and prevent passage of particles, dust, moisture, oil and the like.

Conventional gasket sealants are often pre-fabricated parts which include foam strips, die-cast, rubber O-rings, and the like. A Foam-in-place (“FIP”) has been introduced in recent years as a more economical and superior technology than the conventionally formed gasket sealants. FIP gaskets sealants are foamed, or a matrix filled with voids that is applied in a flowable system and cures to a solid on a substrate. The foams can be a one-component or a two component matrix system. In one method of foaming, a foam is typically produced by mechanically mixing a gas into the matrix; in another method, a foam is formed when a gas is generate as a byproduct of a chemical reaction in the matrix While FIP gasket sealant has various advantages over the conventional gasket sealants, FIP requires special and expensive equipment for applying the material onto the substrates, for precise metering, controlled flow and robotic dispensing are typically necessary to form the exact profile onto the perimeter of an enclosure.

The present invention seeks to provide a more cost-effective method of foaming for FIP gasket sealants without the expensive equipment for application.

### BRIEF SUMMARY OF THE INVENTION

The invention relates to a foam-in-place gasket sealants made from a one-part system, and in particular, from a hot melt adhesive matrix. The hot melt adhesive can be applied and foamed with conventional hot melt foaming devices to form the foam-in-place gasket sealants.

In one embodiment of the present invention, there is provided a foamable hot melt adhesive composition comprising at least about 35 wt %, based on the total weight of the composition, of a rubber block copolymer having a solution viscosity of about 10 cps to about 1,950 cps measured in 25 wt % toluene solution at 25° C.; and a tackifier. The foamable hot melt has (i) a viscosity of about 10,000 cps to about 100,000 cps measured at 180° C., (ii) a compression of about 5% to about 90% measured in accordance with DIN ISO 815, and (iii) a Shore 00 Durometer set hardness of about 10 to about 60 measured in accordance of ASTM D2240. The foamable hot melt adhesive is non-tacky and non-pressure sensitive.

Another embodiment provides an article comprising a substrate and a foamed one-part, non-tacky, non-pressure sensitive hot melt adhesive. The foamed hot melt adhesive composition comprises (a) at least about 35 wt % a rubber block copolymer having a solution viscosity of about 10 cps to about 1,950 cps measured at 25° C.; (b) a tackifier; and (d) optionally, a foaming agent.

Yet another embodiment provides a method of foaming a foamable hot melt adhesive, comprising the steps of: (a) preparing a foamable adhesive composition comprising a at least about 35 wt % of a rubber block copolymer having a solution viscosity of about 10 cps to about 1,950 cps measured at 25° C.; a tackifier; and optionally, a foaming agent (b) heating the foamable adhesive composition to T1; (c) heating the foamable adhesive composition to T2 to foam the foamable adhesive; and (d) applying the foamed adhesive onto a substrate. The T2 is greater than T1 and the foaming agent is activated at temperatures greater than T1.

### BRIEF DESCRIPTION OF THE FIGURES

FIG. 1 is a side-by-side picture of the stable foamed gasket sealant and partially stable foamed gasket sealant.

### DETAILED DESCRIPTION OF THE INVENTION

All documents cited herein are incorporated in their entireties by reference.

The weight percent (wt %) is based on the total weight of the adhesive, prior to any foaming, unless stated otherwise.

The term “polymer” is used herein, refers to a homopolymer or a blend of different (co)polymers.

The present invention is based on the discovery that a foam-in-place gasket sealant can be made with a one-part, hot melt adhesive composition having greater than about 35 wt % of a rubber block copolymer. The foamable adhesive composition can be foamed in a traditional hot melt foaming equipment with very little change to the manufacturing process, whereas traditional foam-in-place sealant materials require special and expensive dispensing equipment.

In one embodiment of the present invention, there is provided a foamable hot melt adhesive composition comprising at least about 35 wt %, based on the total weight of the composition, of a rubber block copolymer having a solution viscosity of about 10 cps to about 1,950 cps measured in 25 wt % toluene solution at 25° C.; and a tackifier. The foamable hot melt adhesive is non-tacky to touch and non-pressure sensitive. The foamable hot melt has (i) a viscosity of about 10,000 cps to about 100,000 cps measured at 180° C. After foaming the foamable hot melt adhesive, the foamed adhesive has (ii) a compression of about 5% to about 90% measured in accordance with DIN ISO 815 and (iii) a Shore 00 Durometer set hardness of about 10 to about 60 measured in accordance of ASTM D2240.

As used herein, block copolymers are two or more homopolymer subunits linked by covalent bonds. The block copolymers have a general configuration of A-B-A or A-B-A-B-A-B-. The polymer end-blocks A are non-elastomeric styrene blocks that impart durability. The elastomeric mid-block B component making up the remainder of the rubber block copolymer is derived from isoprene, butadiene, ethylene, propylene or mixtures thereof, which may be hydrogenated as taught, for example, in U.S. Pat. No. 3,700,633. This hydrogenation of butadiene may be either partially or substantially complete. The rubber blocks may also be functionalized or grafted with an acid or anhydride, for example, to impart additional properties such as superior adhesion to nylon, polyester, aluminum, steel, glass and other polar substrates. The rubber block copolymers are triblock and/or diblocks of the repeating units.

Typical of the linear block copolymers useful herein are the polystyrene-polybutadiene-polystyrene (SBS), polystyrene-polyisoprene-polystyrene (SIS) and e.g., polystyrene-poly(ethylenebutylene)-polystyrene (SEBS) and polystyrene-poly-(ethylenepropylene)-polystyrene (SEPS). These copolymers may be prepared using methods taught, for example, in U.S. Pat. Nos. 3,239,478; 3,427,269; 3,700,633; 3,753,936; and 3,932,327. Alternatively, rubber block copolymer are commercially available from Kraton, Dynasol and Firestone. Particularly preferred rubber block copolymers are styrene-ethylenebutylene-styrene and functionalized styrene-ethylenebutylene-styrene.

Useful rubber block copolymer has a solution viscosity of about 10 cps to about 1,950 cps measured in 25 wt % toluene solution at 25° C. In another embodiment, the solution viscosity of the rubber block copolymer ranges from about 20 to about 900, 800, 700, or 600, and preferably in the range of about 40 to about 500 cps measured in 25 wt % toluene solution at 25° C. The solution viscosity for a rubber block copolymer system comprising multiple rubber block copolymer may be determined by weight average solution viscosity, as shown below.

Weight average solution viscosity is

$$\overline{x} = \frac{{\sum }_{i = 1}^{n} {w}_{i} {x}_{i}}{{\sum }_{i = 1}^{n} {w}_{i}} ,$$

where w is the weight percent of the rubber block copolymer and x is the solution viscosity measured in 25 wt % toluene solution at 25° C.

Solution viscosity can be correlated to melt index, and useful rubber block copolymer has a melt index of about 1 to about 400, at 2.16 kg and 230° C.

The styrene content of the rubber block copolymer is greater than about 15 wt %, based on the weight of the rubber block copolymer. In one embodiment, the styrene content of the rubber block copolymer is greater than about 20 wt %, based on the weight of the rubber block copolymer.

In another embodiment, the rubber block copolymer is a radial or a star block copolymer having a structure of (S-I)ₓY, wherein the copolymer has at least 3 arms, x, branching from a central attachment point Y, and terminating with a styrene end-block.

The rubber block copolymer is present in the foamable hot melt adhesive at a level of at least about 35 wt %, based on the total weight of the adhesive. In another embodiment, the rubber block copolymer is present at levels of greater than about 40 wt %, 45 wt %, and even 50 wt %, based on the total weight of the adhesive.

“Tackifying resins” or “tackifiers” are added to the foamable hot melt adhesive. A tackifier is chosen based on the polymer of adhesives. While miscibility between the tackifier and the polymer is a primary factor in choosing a particular tackifier for a hot melt adhesive composition, less miscible tackifiers may be used in the foamable hot melt adhesives. A typical tackifier has a Ring and Ball softening points, as determined by ASTM method E28, of about 70° C. to about 180° C., more preferably about 95° C. to about 165° C.

Useful tackifying resins may include any resin or mixtures thereof, such as natural and modified rosins including, for example, gum rosin, wood rosin, tall oil rosin, distilled rosin, hydrogenated rosin, dimerized rosin, resinates, and polymerized rosin; glycerol and pentaerythritol esters of natural and modified rosins, including, for example, the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; copolymers and terpolymers of natured terpenes, including, for example, styrene/terpene and alpha methyl styrene/terpene; polyterpene resins having a softening point, as determined by ASTM method E28, from about 70° C. to about 150° C.; phenolic modified terpene resins and hydrogenated derivatives thereof including, for example, the resin product resulting from the condensation, in an acidic medium, of a bicyclic terpene and a phenol; aliphatic etroleum hydrocarbon resins having a Ball and Ring softening point from about 70° C. to about 135° C.; partially hydrogenated aliphatic hydrocarbon resin; aromatic petroleum hydrocarbon resins and the hydrogenated derivatives thereof; partially aromatic hydrocarbon resins; and alicyclic petroleum hydrocarbon resins and the hydrogenated derivatives thereof. Examples of hydrogenated tackifiers particularly suitable include Escorez 5400, 5600 from Exxon Mobil Chemicals, Arkon P 100, Arkon M 100 from Arakawa and Regalite S 1100 from Eastman Chemical, and the like. Also included are the cyclic or acyclic C5 resins and aromatic modified acyclic or cyclic resins.

Preferred tackifiers are synthetic hydrocarbon resins. Included are petroleum hydrocarbon resin, hydrogenated aromatic petroleum hydrocarbon resins, aliphatic/aromatic petroleum derived hydrocarbon resins, hydrogenated aliphatic/aromatic derived hydrocarbon resins, aromatic modified cycloaliphatic resins, hydrogenated aromatic modified cycloaliphatic resins, polyterpene resins, copolymers and terpolymers of natural terpenes, natural and modified rosin, glycerol and pentaerythritol esters of natural and modified rosin, and phenolic modified terpene resins.

Non-limiting examples include aromatic modified and aliphatic hydrocarbon derived resins such as those available from Goodyear under the Wingtack Extra trade name and the Escorez 1300 series from Exxon. A common C5 tackifying resin in this class is a diene-olefin copolymer of piperylene and 2-methyl-2-butene having a softening point of about 95° C. This resin is available commercially under the trade name Wingtack 95. Eastotac series from Eastman are also useful in the invention.

Also useful are aromatic hydrocarbon resins that are C9 aromatic/aliphatic olefin-derived and available from Sartomer and Cray Valley under the trade name Norsolene and from Rutgers series of TK aromatic hydrocarbon resins. Norsolene MI 090 is a low molecular weight hydrocarbon polymer having a Ring and Ball softening point of 95-105° C. and is commercially available from Cray Valley. Endex from Eastman is another useful aromatic hydrocarbon tackifier, with a ring and ball softening point of about 150 to about 170° C.

Alpha methyl styrene such as Kristalex 3085 and 3100 from Eastman Chemicals, Sylvares SA 100 from Arizona chemicals are also useful as tackifiers in the invention.

Preferred tackifiers are end-block resins, C5 resins, dicyclopentadiene, petroleum distillates, hydrogenated hydrocarbons, C9 resins, polyterpenes, rosins, hydrogenated rosins, and rosin esters. More preferred tackifiers include end-block resin, C5 resins, dicyclopentadiene, hydrogenated hydrocarbons, and C9 resins.

Mixtures of two or more described tackifying resins may be required for some adhesives.

Small quantities of alkyl phenolic tackifiers can be blended with additional tackifier agents detailed above to improve the high temperature performance of these adhesives. Alkyl phenolics added in less than 20 wt % of the total weight of the adhesive are compatible and in the proper combination increase high temperature adhesive performance. Alkyl phenolics are commercially available from Arakawa Chemical under the TAMANOL tradename and in several product lines from Schenectady International.

The tackifier will usually be present in an amount from about 20 wt % to about 65 wt %, more preferably from about 20 wt % to about 60 wt %, even more preferably from about 20 wt % to about 55 wt %, based on the total weight of the adhesive.

The hot melt adhesive may further include an additional polymer, a wax, plasticizer, oil, stabilizer, and additives. The type of the hot melt adhesives depends on the end-use applications and desired performance properties.

In one embodiment, the foamable hot melt adhesive for gasket sealants further includes a polyolefin polymer. The polyolefin polymers include C2-C20 copolymers and terpolymers. Depending on the monomer and comonomer selection, and the catalyst in the polymerization, the polyolefin may be substantially amorphous, semicrystalline or crystalline. Depending on the desired crystallinity and molecular weight, various combinations of the monomers may be selected as the polymer for the hot melt adhesives. Both metallocene catalyzed polyolefins with narrow molecular weight distributions and non-metallocene catalyzed (Zigler-Natta catalyzed) polyolefins may be chosen as the base polymer for the adhesive.

Examples of preferred polyolefins include ethylene-alpha olefin, e.g., C₂ with C₃, C₄, C₅, C₆, C₇, C₈, C₉, C₁₀, C₁₁, C₁₂, C₁₃, C₁₄, C₁₅, C₁₆, C₁₇, C₁₈, C₁₉, and/or C₂₀ with a melt index greater than about 5 to about 2,500 g/10 min at 190° C. measured in accordance with ASTM D1238, with the overall crystallinity ranging from about 10% to about 25% of the polymer. Copolymers with C₂, C₄, and/or C₈, with a melt index greater than about 5 to about 2,500 g/10 min at 190° C. measured in accordance with ASTM D1238 and overall crystallinity ranging from about 10% to about 25% of the polymer are more preferred as polyolefin.

In another embodiment, the polyolefin polymer is grafted or copolymerized with a functional group. Suitable functional groups for grafting onto the aforementioned polyolefin include, for example, carboxylic acid, carboxylic acid esters, anhydride, hydroxyl, thiol, epoxy, amine, silane and sulfonate groups. Specific functional groups include silanes, acrylic acid or methacrylic acid, tert-butyl(meth)acrylate, crotonic acid, acrylic acid, acetate, sulfonate, citraconic anhydride, fumaric acid, maleic acid, and itaconic acid, mono- or di-tert-butyl crotonate, mono- or di-tert-butyl fumarate and mono- or di-tert-butyl maleate, maleic anhydride, p-styrenesulfonic acid, 2-(meth)acrylamide-2-methyipropenesulfonic acid, 2-sulfonyl(meth)acrylate, vinyloxazolines, glycidyl(meth)acrylate, allyl glycidyl ether, and the like. The functionalized polyolefin may be present from about 5 to about 15 wt %, based on the total weight of the adhesive.

In another embodiment, a functionalized wax may be substituted for the functionalized polyolefin. Representative examples of suitable waxes include homopolymers and copolymers of various olefins such as ethylene, propylene, butylene, pentene, hexylene, heptene and octene. The wax can be of natural or synthetic origin. Naturally occurring waxes that can be added are vegetable waxes, animal waxes, mineral waxes or petrochemical waxes

Suitable functional groups for grafting onto the aforementioned waxes include, for example, carboxylic acid, carboxylic acid esters, anhydride, hydroxyl, thiol, epoxy, amine, silane, and sulfonate groups. Specific functional groups include silanes, acrylic acid or methacrylic acid, tert-butyl(meth)acrylate, crotonic acid, acrylic acid, acetate, sulfonate, citraconic anhydride, fumaric acid, maleic acid, and itaconic acid, mono- or di-tert-butyl crotonate, mono- or di-tert-butyl fumarate and mono- or di-tert-butyl maleate, maleic anhydride, p-styrenesulfonic acid, 2-(meth)acrylamide-2-methylpropenesulfonic acid, 2-sulfonyl(meth)acrylate, vinyloxazolines, glycidyl(meth)acrylate, allyl glycidyl ether, and the like. The functional wax is present in the foamable hot melt adhesive, preferably at a content less than 5 wt %, based on the total weight of the adhesive.

In one exemplary embodiment, the functionalized wax used in the practice of the invention is a maleic anhydride grafted on a polypropylene wax. A variety of maleic anhydride grafted wax suitable for use herein is available commercially and/or are obtainable using known procedures. For example, maleated polyethylenes are available from Honeywell under the trade names A-C 575 and A-C 573, and from DuPont as products listed as part of their FUSABOND E series. Maleated polypropylenes are available from Honeywell under the trade names A-C 597A, A-C 597P, A-C 907P, A-C 596A, A-C 596P, A-C 950P and A-C 1325P, from DuPont as products listed under the Fusabond P trade named series, from Eastman under the trade names G-3015, G-3003, and from Westlake under the trade name EPOLENE E-43. Any known procedures for producing maleated polyolefins from precursor compounds can be adapted for use to make starting materials suitable for use herein. For example, U.S. Pat. No. 7,256,236, incorporated herein by reference, discloses certain preferred methods for producing maleated polypropylenes suitable for use herein.

In another embodiment, the functionalized wax is a wax that has been copolymerized with a functional group. Representative examples of suitable copolymerizes waxes include terpolymer of ethylene-acrylic ester-maleic anhydride and ethylene-acrylic ester-glycidyl methacrylate, available as LOTADEr® MAH and LOTADER® GMA, respectively.

In a further embodiment, the functionalized wax is an oxidized polyethylene homopolymers, including high density oxidized polyethylene homopolymers. Exemplary oxidized polyethylenes are available from Honeywell under the trade names A-C 673P, A-C 680, A-C 655, A-C 629, A-C 629A, A-C 656, A-C 6702, A-C 307, A-C 307A, A-C 316, A-C316A, A-C 325, A-C 392, A-C 330, A-C 395 and A-C 395A.

Non-functionalized waxes may also be added to the foamable hot melt adhesive. Suitable Waxes include paraffin waxes, microcrystalline waxes, polyethylene waxes, polypropylene waxes, by-product polyethylene waxes, Fischer-Tropsch waxes, oxidized Fischer-Tropsch waxes and functionalized waxes such as hydroxy stearamide waxes and fatty amide waxes. High density low molecular weight polyethylene waxes, by-product polyethylene waxes and Fischer-Tropsch waxes are conventionally referred to in the art as synthetic high melting point waxes.

Paraffin waxes that can be used in the practice of the invention include PACEMAKER® 30, 32, 35, 37, 40, 42, 45 & 53 available from Citgo Petroleum, Co.; ASTOR OKERIN® 236 available from Honeywell; R-7152 Paraffin Wax available from Moore & Munger; R-2540 available from Moore and Munger; and other paraffinic waxes such as those available from Sasol Wax under the product designations SASOLWAX 5603, 6203 and 6805.

The microcrystalline waxes useful here are those having 50 percent by weight or more cyclo or branched alkanes with a length of between 30 and 100 carbons. They are generally less crystalline than paraffin and polyethylene waxes, and have melting points of greater than about 70° C. Examples include VICTORY® Amber Wax, a 70° C. melting point wax available from Baker Petrolite Corp.; BARECO® ES-796 Amber Wax, a 70° C. melt point wax available from Bareco; BESQUARE® 175 and 195 Amber Waxes and 80° C. and 90° C. melt point microcrystalline waxes both available from Baker Petrolite Corp.; INDRAMIC® 91, a 90° C. melt point wax available from Industrial Raw Materials; and PETROWAX® 9508 Light, a 90° C. melt point wax available from Petrowax. Other examples of microcrystalline waxes are Sasolwax 3971 available from Sasol Wax and MICROWAX K4001 available from Alfred Kochem GmBH.

Exemplary high density low molecular weight polyethylene waxes falling within this category include ethylene homopolymers available from Backer Petrolite Corp. as POLYWAX™ 500, POLYWAX™ 1500 and POLYWAX™ 2000. POLYWAX™ 2000 has a molecular weight of approximately 2000, an Mw/Mn of approximately 1.0, a density at 16° C. of about 0.97 g/cm³, and a melting point of approximately 126° C.

The foamable hot melt adhesive comprises preferably less than about 5 wt % of a wax, based on the total weight of the foamable hot melt adhesive. In one embodiment, the foamable hot melt adhesive contains less than about 4 wt %, 3 wt %, 2 wt %, and 1 wt % of a wax component, and in another embodiment, the foamable hot melt adhesive is essentially free of any wax component. Preferred waxes have a melt temperature between 49° C. and 160° C., more preferably between 66° C. and 155° C., and most preferable between 82° C. and 150° C.

Suitable plasticizers include polybutenes, polyisobutylene, phthalates, benzoates, adipic esters and the like. Particularly preferred plasticizers include polybutenes and polyisobutylenes, phthalates such as di-iso-undecyl phthalate (DIUP), di-iso-nonylphthalate (DINP), dioctylphthalates (DOP), mineral oil, aliphatic oils, olefin oligomers and low molecular weight polymers, vegetable oil, animal oils, paraffinic oil, naphthenic oil, aromatic oil, long chain partial ether ester, alkyl monoesters, epoxidized oils, dialkyl diesters, aromatic diesters, alkyl ether monoester and mixtures thereof.

The foamable hot melt adhesives may desirably also contain at least one stabilizer and/or at least one antioxidant. These compounds are added to protect the adhesive from degradation caused by reaction with oxygen induced by such things as heat, light, or residual catalyst from the raw materials such as the tackifying resin.

Among the applicable stabilizers or antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency, and correspondingly, its reactivity; this hindrance thus providing the phenolic compound with its stabilizing properties. Representative hindered phenols include; 1,3,5-trimethyl-2,4,6-tris-(3,5-di-tert-butyl-4-ydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate].

Such antioxidants are commercially available from Ciba Specialty Chemicals and include IRGANOX® 565, 1010, 1076 and 1726 which are hindered phenols. These are primary antioxidants which act as radical scavengers and may be used alone or in combination with other antioxidants such as phosphite antioxidants like IRGAFOS® 168 available from Ciba Specialty Chemicals. Phosphite catalysts are considered secondary catalysts and are not generally used alone. These are primarily used as peroxide decomposers. Other available catalysts are CYANOX® LTDP available from Cytec Industries and ETHANOX® 330 available from Albemarle Corp. Many such antioxidants are available either to be used alone or in combination with other such antioxidants. These compounds are added to the hot melts in small amounts, typically less than about 10 wt %, based on the hot melt adhesive, and have no effect on other physical properties. Other compounds that could be added that also do not affect physical properties are pigments which add color, or fluorescing agents, to mention only a couple. Additives like these are known to those skilled in the art.

Depending on the contemplated end uses of the adhesives, plasticizer stabilizer, and additive may be incorporated in minor amounts, i.e., up to about 20 wt %, into the foamable hot melt adhesive.

The foamable hot melt adhesive of the invention has a viscosity of up to about 100,000 cps measured at 180° C. The aforementioned viscosity range allows the foamable hot melt adhesive to be compatible with a conventional foaming hot melt adhesive applicator. The adhesive must have an adequate mechanical strength or rigidity to maintain the stability of the foams in the matrix of the adhesive. Very low viscosity of the adhesive is insufficient to keep the foams in the matrix because the foams will collapse, whereas foaming adhesives with viscosity greater than 100,000 at 180° C. will require very high pressures in the applicator, e.g., gear pump and nozzle.

The foamable hot melt adhesive has a modulus, G′, that ranges from about 1.0×10⁵ to about less than about 3.0×10⁶ dyn/cm² at 25° C. Adhesives with modulus values less than 3.0×10⁶ dyn/cm² at 25° C. are considered to be tacky and pressure sensitive, according to Dahlquist Criterion. Tacky, pressure sensitive adhesives are not useful as a sealant, particularly, as a gasket sealant, since pressure sensitive adhesives tend to pick up dust and impurities due to the tacky nature. Also, pressure sensitive adhesives tend to deform and flow over time. Surprisingly, the inventive foamable hot melt adhesive, while meeting the Dahlquist Criterion, is non-tacky. The inventive adhesive, unlike a typical pressure sensitive adhesive, is not tacky to touch, and can be used as sealant adhesive, and particularly, as a FIP gaskets sealants.

The foamable hot melt adhesive, after mating the two substrates, should remain bound to the substrates and prevent movement of the substrates. The gasket sealant is subjected to a constant load and will suffer some compression. This compression is defined as the sealant's ability to resist creep deformation under a load over an extended period of time. It is preferable that the foamable hot melt adhesive compress from about 5% to about 90%, measured in accordance with DIN ISO 815 to resist creep deformation.

In addition, the foamable hot melt adhesive has a Shore 00 Hardness set value of about 10 to about 60, measured in accordance of ASTM D2240. Hardness is a measure of the material's response to a small surface stress, and the value is correlated to the materials resistance to the stress. The gasket sealants is preferably soft to provide a better seal and conform to the irregular surfaces of the adjoining substrates.

The foamable hot melt adhesives of the present invention are prepared by blending the components of the adhesive in a range of about 100° C. to about 180° C. to form a one-part, homogeneous blend. Various methods of blending are known in the art. The molten blend is then cooled and may be formed into pellets, blocks, or films for storage or shipping. These pre-formed adhesives can then be reheated and foamed to apply onto substrates. The specific temperature is dependent on the applicators, the application temperature and/or the activation temperature of the foams.

The foams can be introduced into the matrix of the adhesive by mechanically introducing air/gas into the adhesive matrix, chemically producing gases in the adhesive matrix, or by adding microspheres into the adhesive. The components can be mixed and be stored and shipped as a single adhesive as a one-part adhesive. The adhesive can be re-melted to foam the adhesive.

Application of foamable adhesives is known to one of skill in the art. In one embodiment, the foamable hot melt adhesives can be foamed and applied with foam-in-place gasketing applicators, available from Graco and Nordson as FOAM-MELTER.

In another embodiment, a foam-in-place gasketing equipment is not necessary to introduce the foam in the adhesive matrix. For foaming, the hot melt adhesive without a foaming agent is mixed under sufficient pressure with a suitable gas to form a solution or dispersion of the gas in the adhesive, thus forming a foamable adhesive. Upon a sufficient reduction in pressure, as is caused by dispensing the adhesive at atmospheric pressure, the gas evolves from and/or expands in the adhesive to create foams in the adhesive.

The gas is preferably non-reactive, particularly non-oxidative, including nitrogen, carbon dioxide, inert gases such as argon and helium, and mixtures of such. Although oxidative gases, such as air, are typically not preferred, they may be used for heat-stable and low temperature applicable, e.g., 130-250° C., adhesives.

Yet in another embodiment, the adhesive can be foamed with a conventional hot melt applicator with adjustable temperature controls for the hot melt tank and the hose/nozzle system. The molten adhesive can be stored at an unfoamed state in the tank reservoir at T1. The temperature at the hose and nozzle system can be set higher, T2, than the tank reservoir, and be set to a temperature above the decomposition temperature of the foaming agent. As the adhesive moves from the tank to the hose/nozzle, the foamed adhesive can be emitted and applied onto a substrate.

Typical foaming agents include azobisforamide, semicarbazides, tetrazoles, benzoxazine, hydrazine and liquid fluorocarbons. Preferred foaming agents include azodicarbonamide, oxybis(benzenesulfonylhydrazide), toulenesulfonylhydrazide, diphenylsulfone-3,3′-disulfohydrazide, trihydrazinotriazine, p-toulenesulfonyl semicarbazide, 5-phenyltetrazole, isatoic anhydride, sodium bicarbonate, citric acid, and derivatives and combinations thereof. Foams are produced by decomposition of the foaming agents at a given elevated temperature. The foaming agents may be in range of about 0.05 to about 10 wt %, preferably from about 0.1 to about 8 wt %, more preferably from about 0.5 to about 7 wt %, based on the total foamable adhesive.

Decomposition of the foaming agents release N₂, CO, NH₃, H₂O and/or CO₂ gases/vapors that forms the foam matrix cells. Based on the decomposition temperature of the foaming agents, subjecting the foamable hot melt adhesive to a temperature to or above the decomposition temperature of the foaming agents release gas in the adhesive and foam is created. To make a more efficient process, the foamable adhesive is melted at one temperature (T1), and the molten adhesive is moved to a different chamber or nozzle set to a higher temperature (T2), wherein T2 is higher than T1. T2 is typically chosen on the foaming agent's decomposition temperature. With the use of pressure, the foamed adhesive is emitted out into ambient pressure onto a substrate.

The choice of T2 depends on the decomposition temperature of the foaming agents and the viscosity of the hot melt at the application temperature. The T2 of the hose/nozzle must be near, at or higher than the decomposition temperature of the foaming agent to initiate decomposition of the foaming agents and foam the adhesive. However, the T2 should not be too high to decrease the adhesive viscosity to a level that cannot support the foam in the adhesive matrix.

Additional additives such as a kicker, to alter the decomposition temperature of the foaming agent, may be added in combination with the foaming agents. Exemplary kickers include zinc oxide, zinc stearate, urea and triethanolamine, and the like.

Microspheres, as pre-expanded and expandable, can also be added in the foamable hot melt adhesive. Expandable microspheres are made of thermoplastic material as a shell that encapsulates a low boiling point hydrocarbon. Upon heating, the hydrocarbon exerts a pressure on the internal shell wall which then softens and expands. Depending upon the boiling temperature of the hydrocarbon, the melting and foaming of the adhesive can be controlled to meet the desired application needs. For pre-expanded microspheres, they can be directly added to the foamable hot melt adhesive.

The foamed adhesive may be applied to various substrates, including polypropylene, polyethylene, chrome plated, polyester, polystyrene, polycarbonate, acrylonitrile butadiene styrene, aluminum, Nylon, glass, and the like. The adhesive is preferably, applied onto a space in between two mating surfaces. The adhesive foams in place, and tightly seals the space in between the two surfaces by conforming and compensating for any irregularities of the two joining surfaces. Depending upon the end use, the formed gasket provides insulation, dampens vibration and sound, and prevents passage of particles, moisture and air. It is preferable that the foamed adhesive shows low shrinkage, preferably shrinks less than 50%, after application. The inventive foamed adhesive has low deflection force which minimizes any substrate damage, high conformity to irregular surfaces to maintain a seal, provides vibration dampening and cushioning, and seals against air, dust and moisture.

### EXAMPLES

Various adhesive samples were prepared with the components shown in Table 1. The hot melt adhesives were prepared by combining the polymers, stabilizer, and plasticizer in a reservoir with a blade mixer at 170-190° C. until a homogeneous mixture was formed. Tackifiers were then added to the homogenous mixture until the mixture became homogenous, with the highest softening point tackifier being added first, and the lowest softening point tackifier being added last. The temperature of the mixture was lowered to about 165° C., and 5% of a foaming agent, citric acid, was added and mixed until it became homogenous.

The viscosity of the unfoamed material was obtained using an Ares-M rheometer, with a Steady Rate test. The sample was placed in between two parallel plates (25 mm geometry diameter) with a 1 mm gap. The sample was tested at different shear rates from 1 s-1 to 100 s-1. The reported viscosity measurement in Table 1 was at shear rate of 10s⁻¹ at 180° C.

Storage Modulus—The storage modulus (G′) was obtained using the Ares-M rheometer, with a Dynamic Temperature Ramp test. An unfoamed sample was placed in parallel plates (25 mm geometry diameter) with a 1 mm gap. The Dynamic temperature was conducted by ramping down from 180° C. to 0° C., with a frequency of 10 rad/sec and at a cooling rate of 5° C./minute. The reported storage modulus (G′) in Table 1 was at 25° C.

The adhesive was foamed with a hot press and an oven Blue M Stabil-Therm Mechanical Convection Horizontal Air-Flow Electric Utility Oven, model OV-490A-2. Using the hot press, the foamable adhesive sample was placed in between two brass metal plates and release paper to obtain a 4-6 mm thick sample. The sample was then taken out of the press and then cooled for at least one hour at 23° C. Once cooled, a 30×30 mm square sample was cut. The cut sample was placed on a Teflon plate and put into the oven at 215° C. for 10 minutes. The foamed sample was then cooled at 23° C. for an hour. The foamed adhesives were test for compression, hardness, foam stability and peel adhesion, and their results are also shown in Table 1.

The compression was tested on the foamed adhesive in accordance with DIN ISO 815.

The Shore 00 Durometer set hardness was tested on the foamed adhesive in accordance with ASTM D2240.

The foamed adhesive was tested for foam stability. The sample adhesive was deemed to be stable when the thickness did not decrease by more than 50% than the original thickness; and the adhesive was deemed to be partially stable when the thickness decreased by more than 50%.

The peel adhesion values were obtained with a 90° Peel test at 23° C. with an Instron. The adhesion strength of the sample on acrylonitrile butadiene styrene (ABS), polycarbonate (PC) and chrome substrates was conducted, with a minimum of three samples on each of the substrates. The sample was prepared by placing the unfoamed adhesive and a 1 mm brass plate in between a PET and a release liner. The sample was cut to fit the testing substrate, having at least 1″×6″ (2.54 cm×15.24 cm). The release liner was removed and the sample was place into the oven at 193° C. for 10 minutes to foam the adhesive. The sample was then immediately affixed to the substrate with a 1 kg load and then aged at 23° C. for 30 minutes. The substrate was placed onto the Instron with a 90° peel fixture and the sample was pulled.

TABLE 1

| Component | Ex 1 | Ex 2 | Ex 3 | Ex 4 | Ex 5 | Ex 6 | C Ex A | E Ex B |
|---|---|---|---|---|---|---|---|---|
| SEBS¹ | 30 | 27.5 | 25 | 22.5 | 26 | 27.5 | 0 | 0 |
| SEBS² | 30 | 27.5 | 25 | 22.5 | 26 | 27.5 | 0 | 30 |
| SEBS³ | 0 | 0 | 0 | 0 | 0 | 0 | 60 | 25 |
| Calculated | 145 | 145 | 145 | 145 | 145 | 145 | 4200 | 2335 |
| SEBS solution | | | | | | | | |
| viscosity (wt | | | | | | | | |
| average) at | | | | | | | | |
| 25° C. | | | | | | | | |
| Metallocene | 0 | 5 | 10 | 15 | 0 | 0 | 0 | 0 |
| catalyzed | | | | | | | | |
| polyethylene- | | | | | | | | |
| octene | | | | | | | | |
| Wax⁴ | 0 | 0 | 0 | 0 | 8 | 5 | 0 | 0 |
| Tackifier⁶ | 34.5 | 34.5 | 34.5 | 34.5 | 34.5 | 34.5 | 39.5 | 44.5 |
| Plasticizer (oil) | 5 | 5 | 5 | 5 | 5 | 5 | 0 | 0 |
| antioxidant | 0.5 | 0.5 | 0.5 | 0.5 | 0.5 | 0.5 | 0.5 | 0.5 |
| Foaming agent | 5 | 5 | 5 | 5 | 5 | 5 | 5 | 5 |
| Viscosity cP at | 67000 | 69000 | 65000 | 68000 | 45000 | 60000 | 1182000 | 298150 |
| 180° C. | | | | | | | | |
| G′ at 25° C., | 1.0 | 1.2 | 1.5 | 0.31 | 2.4 | 2.4 | N/A | N/A |
| ×10⁶) | | | | | | | | |
| (dyn/cm\hat{ }2) | | | | | | | | |
| Compression | 44 | 72 | 67 | 75 | N/A | N/A | N/A | N/A |
| set (%) | | | | | | | | |
| Shore 00 | 54 | 53 | 54 | 53 | N/A | N/A | N/A | N/A |
| (foam) | | | | | | | | |
| Foam stability | stable | stable | stable | stable | Partially | Partially | N/A | N/A |
| | | | | | stable | stable | | |
| Adhesion 90° | | | | | | | N/A | N/A |
| peel (lbf/in) | | | | | | | | |
| ABS | 3.7 | 3.0 | 3.3 | 2.9 | 1.5 | 2.5 | N/A | N/A |
| PC | 0.7 | 1.4 | 1.5 | 1.5 | 1.8 | 0.7 | N/A | N/A |
| Chrome | 0.9 | 0.9 | 1.7 | 1.7 | 2.5 | 1.4 | N/A | N/A |

¹styrene/content 30%; Solution viscosity of 200 cps at 25° C.
²styrene content 18%; Solution viscosity of 90 cps at 25° C.
³styrene content 13%; Solution viscosity of 4,200 cps at 25° C.
⁴AC-597P (Honeywell)
⁵hydrocarbon or aromatic resin, cycloaliphatic resin

Samples having a viscosity greater than 100,000 at 180° C. were not further tested for performance since very high application pressure is required to apply the samples onto the substrates. Examples 1-4 had acceptable compression, hardness and foam stability. Also, Examples 1-4 had superior adhesion to ABS substrate and acceptable adhesion to PC and chrome.

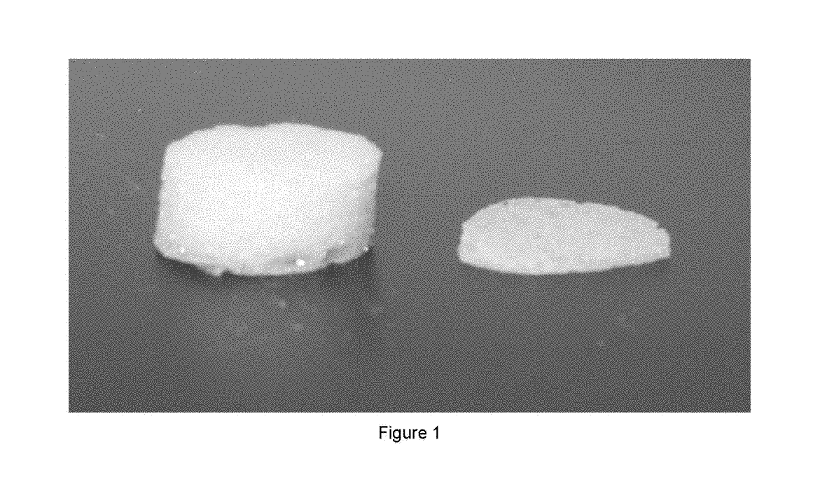

Pictures of Sample 3 and Sample 5 are shown in FIG. 1. Sample 3 had stable foam and maintained its height, whereas Sample 5 partially collapsed after foaming.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

We claim:

1. A foamable hot melt adhesive composition comprising:
(a) at least about 35 wt % a rubber block copolymer having a solution viscosity of about 10 cps to about 1,950 cps measured in 25 wt % toluene solution at 25° C.; and
(b) a tackifier;
wherein the adhesive has (i) a viscosity of about 10,000 cps to about 100,000 cps at 180° C.,
wherein the foamed adhesive has (ii) a compression of about 5% to about 90% measured in accordance with DIN ISO 815 and (iii) a Shore 00 Durometer set hardness of about 10 to about 60 measured in accordance ASTM D2240; and
wherein the total wt % of the component equal to 100 wt % of the adhesive.

2. The foamable hot melt adhesive of claim 1, wherein the rubber block copolymer is a linear block copolymer having a styrene content greater than about 15wt %, and
wherein the linear block copolymer is selected from the group consisting of styrene-butadiene-styrene, styrene-isoprene-styrene, styrene-ethylene-butylene-styrene, styrene-ethylene-propylene-styrene, and functionalized styrene-butadiene-styrene, functionalized styrene-isoprene-styrene, functionalized styrene-ethylene-butylene-styrene, functionalized styrene-ethylene-propylene-styrene, and mixtures thereof.

3. The foamable hot melt adhesive of claim 2, wherein the linear block copolymer is styrene-ethylenebutylene-styrene or functionalized styrene-ethylenebutylene-styrene.

4. The foamable hot melt adhesive of claim 1, wherein the rubber block copolymer is a radial or a star block copolymer having a structure of (S-I)xY, wherein the copolymer has at least 3 arms, x, branching from a central attachment point Y, and terminating with a styrene end-block.

5. The foamable hot melt adhesive of claim 1, wherein the tackifier is selected from end-block resins, C5 resins, dicyclopentadiene, petroleum distillates, hydrogenated hydrocarbons, C9 resins, polyterpenes, rosins, hydrogenated rosins, rosin esters and mixtures thereof.

6. The foamable hot melt adhesive of claim 1, further comprising a polyolefin homopolymer or copolymer modified with a functional group.

7. The foamable hot melt adhesive of claim 6, wherein the polyolefin copolymer is a comonomer selected from the group consisting of C2, C4, C5, C6, C7, C8, C9, C10, C11, C12, C13, C14, C15, C16, C17, C18, C19 , C20, and mixtures thereof.

8. The foamable hot melt adhesive of claim 7, wherein the comonomer are selected from the group consisting of C2, C4, C8 and mixtures thereof.

9. The foamable hot melt adhesive of claim 8, wherein the functional group of the polyolefin copolymer is modified with a functional group is selected from the group consisting of carboxylic acid, carboxylic acid esters, anhydride, hydroxyl, thiol, epoxy, amine, silane, sulfonate groups and derivatives thereof.

10. The foamable hot melt adhesive of claim 8, wherein the polyolefin copolymer with a functional group is present at about 5 to about 15 wt %, based on the total weight of the adhesive.

11. The foamable hot melt adhesive of claim 8, which has less than 5 wt % of a wax.

12. The foamable hot melt adhesive of claim 1, further comprising a plasticizer, an antioxidant, a stabilizers, or an additive.

13. The foamable hot melt adhesive of claim 1, further comprising a foaming agent selected from a gas, a foaming agent or a plurality of microspheres.

14. The foamable hot melt adhesive of claim 13, wherein the foaming agent is a foaming agent selected from the group consisting of azodicarbonamide, oxybis(benzenesulfonylhydrazide), toulenesulfonylhydrazide, diphenylsulfone-3,3′-disulfohydrazide, trihydrazinotriazine, p-toulenesulfonyl semicarbazide, 5-phenyltetrazole, isatoic anhydride, sodium bicarbonate, citric acid and mixtures thereof.

15. A foamed adhesive of claim 1.

16. An article comprising a substrate and a foamed hot melt adhesive comprising:
(a) at least about 35 wt % a rubber block copolymer having a solution viscosity of about 10 cps to about 1,950 cps measured in 25 wt % toluene solution at 25° C.;
(b) a tackifier; and
(c) optionally, a foaming agent.

17. The article of claim 16 wherein the substrate is a polypropylene, polyethylene, chrome plated, polyester, polystyrene, polycarbonate, acrylonitrile butadiene styrene, aluminum, Nylon, or glass.

18. The article of claim 17 which is a gasket.

19. A method of foaming a foamable adhesive composition comprising the steps of:
(a) preparing a foamable adhesive composition comprising at least about 35 wt % of a rubber block copolymer having a solution viscosity of about 10 cps to about 1,950 cps measured in 25 wt % toluene solution at 25° C.; a tackifier; and a foaming agent;
(b) heating the foamable adhesive composition to T1;
(c) heating the foamable adhesive composition to T2 to foam the foamable adhesive; and
(d) applying the foamed adhesive onto a substrate;
wherein T2 is greater than T1 and
wherein the foaming agent is activated at temperatures greater than T1.

20. The method of foaming a foamable adhesive composition of claim 19 wherein foaming agent is selected form the group consisting of azodicarbonamide, oxybis(benzenesulfonylhydrazide), toulenesulfonylhydrazide, 5-phneyltetrazole, sodium bicarbonate, citric acid, acrylic copolymer and mixtures thereof.
